(19) United States
(12) Patent Application Publication
(10) Pub. No.: US 2007/0251999 A1
(43) Pub. Date: Nov. 1, 2007

(54) OPTICAL DATA CARDS AND TRANSACTIONS

(76) Inventors: Edward H. Bohlke III, New York, NY (US); Peter Ellul, New York, NY (US); David J. Brown, New York, NY (US); Camilus Lim Gim Seng, Singapore (SG)

Correspondence Address: TORYS LLP, 79 WELLINGTON ST. WEST, SUITE 3000, TORONTO, ON, M5K 1N2, CA

(21) Appl. No.: 11/689,369

(22) Filed: Mar. 21, 2007

Related U.S. Application Data
(60) Provisional application No. 60/784,156, filed on Mar. 21, 2006.
(60) Provisional application No. 60/865,424, filed on Nov. 11, 2006.

(51) Int. Cl. G06K 5/00; G06K 19/00; G06K 19/06

(52) U.S. Cl. 235/380; 235/487; 235/492; 235/493

(57) ABSTRACT

Improved optical data cards 20, and compatibly-configured systems, methods, and software are useful in advertising, communications, and the completion of on-line and other electronically-processed transactions. Optical data cards 20 comprise optically readable data comprising unique card identifiers and seating devices configured for seating the cards 20 in an optical reading devices. When used in accordance with suitably-configured systems and processes, the cards 20 are useful, for example, in furthering secure electronic transactions in goods and services. Optical data cards 20 also may comprise a non-optical data set readable by non-optical reading devices such as for example magnetic swipe readers and RFID readers

### CROSS REFERENCE TO RELATED APPLICATIONS AND INCORPORATION BY REFERENCE

This application claims priority to U.S. Provisional Patent Application Ser. No. 60/784,156, entitled Secure Optical Transaction Card and System and Method of Using Same and filed Mar. 21, 2006; and to U.S. Provisional Patent Application Ser. No. 60/865,424, entitled Electronic Data Card and filed Nov. 11, 2006. The entire disclosure of each is incorporated herein by reference.

### BACKGROUND

The invention relates to optical data cards useful in advertising, sales, and other fields. More particularly, the invention provides in various aspects optical data cards comprising unique card identifiers, which may be stored in optically- and/or non-optically readable formats.

Optical data cards, which comprise machine-readable data encoded in formats readable by, for example, optical data-reading devices such as CD and DVD players, are known in the art. Such cards may take many forms, shapes and sizes, including wallet-sized cards that are similar in size to business cards, and are useful for disseminating relatively large amounts of data in a convenient form factor that takes up little space and that people are accustomed to carrying with them, collecting, storing, keeping and/pr referring to at a later time. See, for example, co-owned U.S. Pat. Nos. 5,982,736, 6,016,298, 6,510,124, and 6,762,988 which describe unique optical cards comprising seating devices which enable the use of wallet-sized optical data cards with conventional CD and DVD readers. The entire contents of each of these patents is hereby incorporated by reference.

Further, non-optical cards such as credit cards, debit cards, stored value cards, gift cards, and access cards are well-known as convenient non-cash alternatives for conventional and online shopping and for providing more personalized gifts than simply giving cash as well as for providing a convenient alternative to keys (such as hotel room passes) or fast-access tickets (such as RFID cards that are touched to an RFID reader to gain access to a venue). Many systems have been developed to take advantage of the convenience of such non-optical cards, including for example magnetic swipe readers, RFID readers, and smart card readers. Further, most online retailers accept non-optical cards as payment for online transactions. However, the increased use of non-optical cards as a means of online payment also created an increased security risk because hackers can intercept open and closed loop card numbers in order to make unauthorized transactions. There have been many attempts to increase online security, such as for example encrypting data and using personal and/or one-time identification numbers. However, such measures are susceptible to interception by hackers that can decrypt data or can use keystroke software to steal the personal identification number while it is being typed by the card's authorized user during an online transaction.

It is desirable to combine the large amount of data that can be conveniently carried on a wallet-sized optical card with the transactional convenience of a non-optical card in order to enhance the performance, usefulness and appeal of each type of card. For example, merchants could use such cards to simultaneously promote offerings (for example using links to websites, promotional materials, product offerings etc) and enable the processing of conventional and/or electronically-based transactions. However, optical and non-optical cards are read in different ways, by different readers that require different physical attributes. In one aspect, the invention solves this problem by providing cards having dimensions and other attributes that allow data sets to be read by both optical and non-optical readers.

Further, it is desirable to increase the security of online transactions. In various aspects the invention provides optical cards having unique, encoded machine-readable card identifiers that are impervious to many means by which hackers obtain confidential and other information from computer users.

### SUMMARY OF THE INVENTION

The invention provides improved data cards useful in, for example, advertising, communications, and the completion of on-line and other electronically-processed transactions.

In one aspect, for example, the invention provides an optical data card which can be used in the completion of an on-line and/or otherwise electronically-processed transaction. Such a card can comprise an optically-readable data set supported by a substrate, the optically-readable data set comprising data representing a unique or other card identifier; and a seating device configured to seat the optical data card in an optical reading device. Such seating devices can, for example, be advantageously configured to adapt the card for reading by optical reading devices such as for example a conventional CD and/or DVD reading device.

In another aspect, the invention provides an optical data card configured for reading by a non-optical data-reading device, the data card comprising a substrate supporting at least one data set, the at least one data set readable by an optical data-reading device and the same or an other data set readable by the non-optical data-reading device, and a seating device configured to seat the optical data card in the optical reading device. The card can be configured, as for example by suitable physical configuration, for simultaneous and/or sequential reading by an optical and non-optical reading device. Optical and non-optical data reading devices suitable for use in implementing the invention can include, for example, known or later-developed CD and DVD readers, magnetic stripe reading devices, radio-frequency identification (RFID) devices, smart chip devices, and other devices. Communication by a reader can be accomplished by or otherwise involve physical contact between relevant portions of the card, as for example in the case of swiping a card bearing a magnetic data stripe through a card reader or connecting a port for an embedded micro circuit to a communications device, or not, as for example in the case of RFID and laser-based CD/DVD reading. In some embodiments, data stored by cards according to this aspect of the invention can include data representing the same information stored in both optically- and non-optically readable formats.

In another aspect the invention provides systems useable for processing transactions between card users such as consumers and/or point of sales representatives or suppliers of goods or services. Such systems can comprise one or more computers or other data processors configured to receive, in processing a transaction, from a card user system a signal configured for causing the processor to initiate a transaction process, the signal generated by the card user system upon reading of an optical data card by an optical reading device associated with the card user system; receive from the card user system, as a part of the same or another signal, data read from the optical data card and representing a card identifier associated with the optical card; and using the received signal or signals, output signals representing data useable by a supplier system for furthering a transaction.

In processing transactions such systems can use data stored on and accessed from the optical cards in both optically- and non-optically formats. Data used in processing the transactions can include card identifiers such as serialization or other codes.

Data stored on cards provided in accordance with the invention can be stored in a wide variety of formats. For example, as will be understood by those skilled in the relevant arts, data stored in optical format can be provided in CD, DVD, readable and/or writable, erasable, Blu-ray, HD DVD, and any other formats now known or later developed. Data can also be stored in volatile or persistent memory structures or devices such as magnetic stripes (or strips), and memories associated with RFID and microcircuit devices such as smart chips.

In another aspect the invention provides methods useful for processing transactions between card users such as consumers and/or point of sales representatives or suppliers of goods or services. The methods can be performed by one or more computers or other data processors and can comprise receiving from a card user system a signal configured for causing the processor to initiate transaction process, the signal generated by the card user system upon reading of an optical data card by an optical data-reading device associated with the card user system; receiving from the card user system, as a part of the same or another signal, data read from the optical data card and representing a unique card identifier associated with the optical card; and using the received signal or signals, outputting signals representing data useable by a supplier system for furthering a transaction.

In some embodiments of such methods, the signal generated by the card user system upon reading of an optical data card by an optical data-reading device associated with the card user system is generated automatically. That is, no specific transmission or generation command is required to be input by the user of the card user system. For example, placement of an optical data card according to the invention in an optical drive on a card user system can cause an auto-boot or auto-execute command to be generated by the card user system, and to provide the signal to the supplier system. In other embodiments, it may be advantageous to require the entry of a suitably-configured command by a card user or other system user.

In further aspects and embodiments the invention provides computer-useable media comprising computer-readable code configured to implement methods and processes according to the invention.

Among the advantages offered by the invention is improved transaction security. The automatic reading of card identifiers and/or other sensitive or confidential information, or other information subject to possible misuse, without the use of keystrokes or other interpretable input commands, can prevent hackers and other wrongdoers from gaining access to such information. In addition, since such data may be used in a transaction without being manually inserted into a transaction request, even if an unencrypted dataset is intercepted it would be extremely difficult to complete an unauthorized transaction because a hacker would not know how to interpret the intercepted information in such as way that it would be used fraudulently.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIGS. 1-4 are schematic diagrams of optical data cards in accordance with embodiments of the invention.

FIGS. 5 and 6 are schematic diagram of systems suitable for use in using cards and implementing processes in accordance with the invention.

FIGS. 7-9 are schematic diagrams of embodiments of processes suitable for use in implementing aspects of the invention.

### DETAILED DESCRIPTION

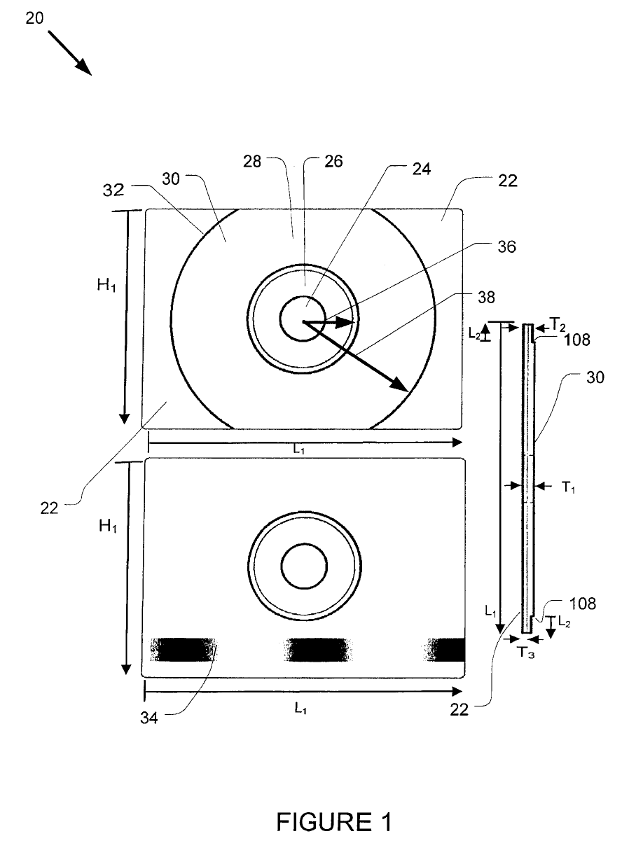

FIGS. 1A, 1B and 1C are schematic diagrams of an optical data card 20 in accordance with an embodiment of the present invention. FIG. 1A provides a top view, FIG. 1B provides a bottom view and FIG. 1C provides a side view. Optical data card 20 comprises substrate 22, optical layer 30 which has data area 28, which may for example be bounded by inner radius 36 and outer radius 38, drive opening 24 which is bordered by placement area 26, and seating device 32.

Optical data card 20 may be used as an optical data card (such as a CD or DVD) and in a variety of additional ways including, but not limited to, as a credit card, debit card, gift card, stored value or open loop card, transit card, security pass, event ticket, membership card, health/medical information card, access card, or promotional card. Optical data card 20 may include both optical data and non-optical data that can be read by an optical data-reading device and a non-optical data-reading device respectively. By way of example, optical data card 20 may be read by a conventional CD-ROM or DVD reader and/or by a conventional magnetic swipe reader. Thus, optical data card 20 has the physical characteristics (e.g., size, materials, construction) required by both optical and non-optical data-reading devices.

Optical data card 20 can have different shapes, including those described below and/or recommended by the American National Standards Institute (ANSI) and/or International Standards Organization (ISO). For example, cards according to the invention may be approximately bounded by dimensions that correspond to a standardized card format of approximately 90 mm in length and 70 mm in height, preferably 85 mm in length and 65 mm in height, and more preferably 85 mm in length and 54 mm in height, although other dimensions are contemplated and thus considered to be within the scope of this invention.

Optical data card 20 may have a drive opening 24 (as described below) having for example standard dimensions that are well known in the art.

Although FIGS. 1A-1C show a non-optical data element (a magnetic data stripe), it is not contemplated or required that all optical cards according to the invention include such non-optical data elements.

Substrate 22 may be similar to a conventional wallet-sized substrate, such as that used for credit cards, having a generally rectangular shape (which may include, for example, rounded corners). Substrate 22 may for example be made of PVC or any other material providing similar characteristics and/or providing characteristics in conformance with the ANSI, ISO, and/or other standards or criteria for credit card substrates.

As will be discussed further below with respect to FIG. 1C, in the embodiment shown the shape and thickness of substrate 22 preferably allow optical data card 20 to be read by a non-optical data-reading device such as by swiping optical data card 20 through a magnetic swipe reader—at least along the path of a magnetic stripe such as magnetic stripe 34 of FIG. 1B. Card 20 can also be compatible with non-optical reading devices such as RFID interrogators and/or communications ports adapted to interact with embedded RFID or smart chips, etc.

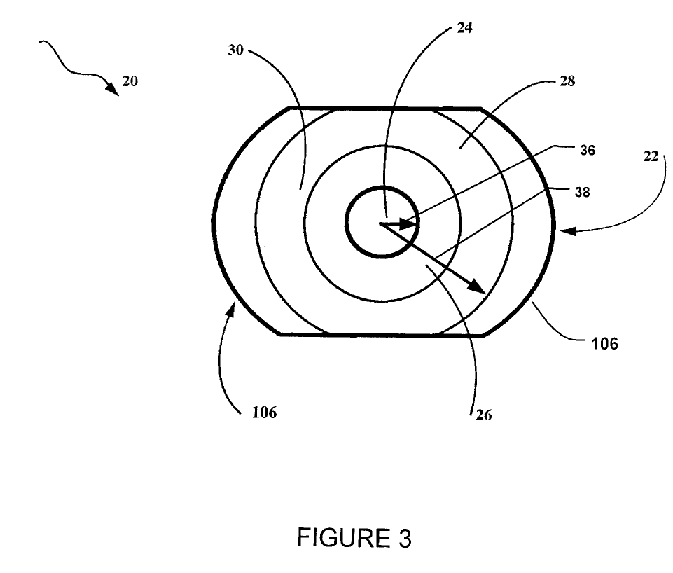

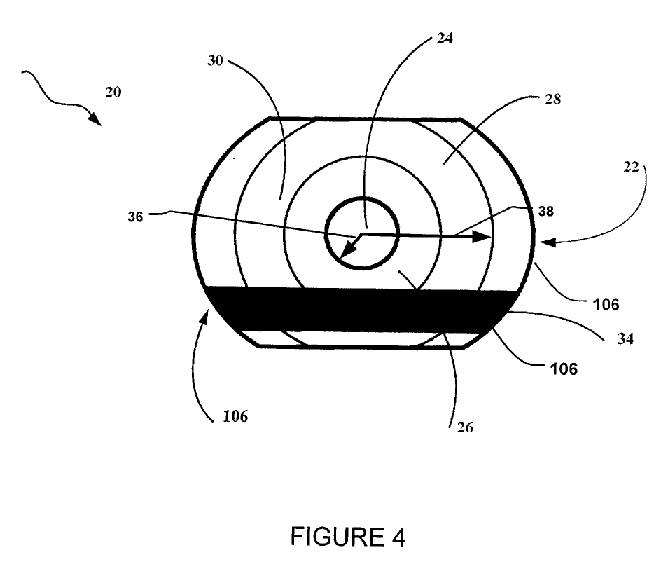

In addition, the configuration of card 20 and substrate 22 allow, as for example through the provision of suitably-configured seating device(s) 32, optical data card 20 to be read by an optical data-reading device such as a CD-ROM drive. For example, substrate 22 can be appropriately shaped, evenly weighted for revolution, and registrable within conventional CD-ROM, DVD and other optical data-reading devices such as card readers made by DED of the United Kingdom. In the embodiment shown in FIGS. 1A-1C, substrate 22 can engage with and register with conventional CD-ROM drives, not via substrate 22 but via seating device 32, as will be more fully discussed below. However, as described and discussed with respect to FIGS. 3 and 4, substrate 22 may register optical data card 20 with for example the CD-ROM, or DVD drive.

Optical layer 30 comprises data area 28 for embedding data, placement area 26 for handling the optical layer, and drive opening 24 to allow optical layer 30 to register with a drive and therefore be spun and read. These elements will be discussed in more detail below.

Optical layer 30 may be made of polycarbonate or any other material exhibiting the desired characteristics such as being able to embed data thereon. Optical layer 30 may be between 0.3 mm and 1.2 mm thick and is preferably about 0.6 mm thick. Conventional optical layers may for example be of CD or DVD format.

Optical layer 30 may be attached by adhesive, heat bonding, common forming, or any other suitable means, to substrate 22. In an embodiment where the substrate is attached by adhesive, the overall thickness of optical data card 20 may be approximately 0.95 mm; where 0.12 mm may be due to glue, 0.6 mm from optical layer 30 and 0.23 mm from substrate 22. Although the ISO standard for credit card thickness is 0.762 mm, optical data card 20 is compatible with most magnetic swipe readers, as such readers can accommodate cards having widths of approximately 1.2 mm or less. During testing, optical data cards 20 having such thicknesses have proven to be readable by both non-optical data-reading devices such as magnetic swipe readers and optical data-reading devices such as CD-ROM and DVD drives.

In various other embodiments an optical card may comprise, in addition to or in lieu of a conventional substrate, an underlying optical layer that extends to form a wallet-sized rectangular card and has a thickness of about 0.3 mm. The substrate and/or optical data portion(s) of a card may comprise an elevated or otherwise offset portion having a plan shape similar to that of a hockey rink, and a thickness of about 0.6 mm. One or more edges of the substrate, and/or shoulders or ridges 108 of such an offset hockey-rink-shaped portion or other portion(s) of the card 20, can be configured so as to form an interface seat configured to engage the seating and/or drive mechanism of a card reading device, for example to position the card on the 8 cm ring of a conventional CD or DVD reading tray much as described in U.S. Pat. Nos. 5,982,736, 6,078,557, 6,304,544, and D502,469 to Pierson, the contents of each of which is incorporated herein by reference.

One or more intermediary layers (not shown) may be provided between optical layer 30 and substrate 22. Such intermediary layers may for example allow decorative indicia to be provided on visible surfaces of optical data card 20 or may provide additional functionality to optical data card 20, depending on the nature of the one or more intermediary layers. For example, as will be understood by those skilled in the relevant arts, a card user's name, a company logo, or an advertisement may be provided. Intermediary layers and/or substrates may also support embedded or otherwise mounted or attached data storage and/or processing devices such as embedded RFID or microcircuit devices such as smart chips.

Optical layer 30 allows for data to be embedded as in data area 28. Data area 28, and therefore the data embedded in optical layer 30 can be located substantially anywhere on optical layer 30. Embedded data will be further described below but the data may be embedded as described in U.S. Pat. No. 6,816,415, the entire contents of which are incorporated by reference. Optical layer 30 can have data embedded in it radially between R2 and R3 of FIG. 1A. R2 may for example be a radial distance of approximately 8 mm while R3 may be a radial distance of 30 mm.

Optical layer 30 may comprise a single surface encoded with readable data, or two. Where for example optical layer 30 is bound to an opaque substrate 22, or where a label is provided on one side of optical layer 30, only one surface may be readable. However, optical layer 30 may have two readable surfaces where no substrate or label is used.

Optical layer 30, and data area 28 in particular, can be recordable and allow a user to record content. Alternatively, or in addition, optical layer 30 can have previously-stored content or datasets, provided for example by an issuer of optical data card 20. Such content can be read only, or rewriteable. Examples of such user-provided or previously-stored content include information and/or multimedia content relating to a supplier's goods or services, information and links for connecting to or uploading from a supplier's website or a user's bank's online banking services, links allowing topping up of stored value or available credit for an optical data card having a unique card identifier such as a serialization number, or links to third party websites such as for example PayPal®, games, entertainment, audio or video content, or promotional materials. Optical layer 30 may store large data files utilizing technology such as, for example, Blu-ray, HD DVD, or any other technology. A further example of such content may include a serialization code or other unique card identifier that is used to identify optical data card 20, for example when such card is used in online or other electronic transactions.

Data area 28 comprises one or more portions of optical layer 30 that are used to store data. Data area(s) 28 may be substantially coextensive with optical layer 30 and may occupy all or any portion of optical layer 30 other than drive opening 24 and placement area 26—if such are present.

In various embodiments a user's financial information such as information which is typically contained in a magnetic stripe, or an RFID, of a credit, debit, or any other stored value or open loop card, as well as other financial or other information deemed relevant by a card issuer, can be encoded as an aspect of at least one optical dataset on an optical card 20 such that it can be read directly by an optical drive of a customer system 10.

Along with many other types of information, data encoded in data area 28 may represent one or more one card identifiers suitable for identifying the optical data card 20 and/or any features or attributes thereof. The same and/or other identifiers may also be provided on the card 20 in non-optically-readable form. Such a card identifier may uniquely identify a card, a series or one or more sets of cards, and/or other features or attributes of the card(s), including, for example, the issuer of the card, a supplier associated with the distribution of the card or any content encoded thereon, a value associated with the card and useful in completing transactions, or other information.

In various embodiments, for example, the card identifier comprises one or more of a number or other code all or any portion of which uniquely identifies an optical data card 20 on which the identifier is stored; a merchant or other supplier; a gift, purchase, or other value originally stored on the optical data card 20; the manner by and/or location at which the card was distributed (ie. purchased in a store, distributed at a tradeshow, offered through a third party, donated/given as a prize etc); the date the card was produced or entered in circulation; and the series (ie. the first series of cards that were distributed in a given year, as opposed to the third series).

Data encoded on the card and/or the card identifier, can further include a card user's financial data such as their credit card number and expiry, their bank, bank account number, PIN number, and any other financial data to enable initiation and completion of a transaction.

Each of the above pieces of information contained in the card identifier may be represented by a specific number of bits, bytes, or by common data structures (integer, long, floating point etc). Such card identifiers can include any randomly- or systematically-determined symbols or combinations of symbols, such as numbers, letters, other symbols or a combination of any of the above, or in some circumstances a combination of a user's financial data and random symbols.

In addition to being stored in optically-readable formats on the optical card 20, such card identifiers may be stored in any one or more non-optically readable data sets. For example, such identifiers may be stored in magnetic strips, RFID and/or smart chip devices.

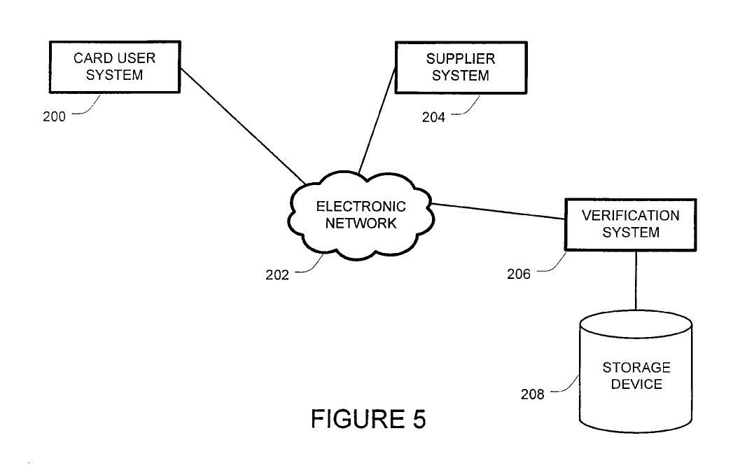

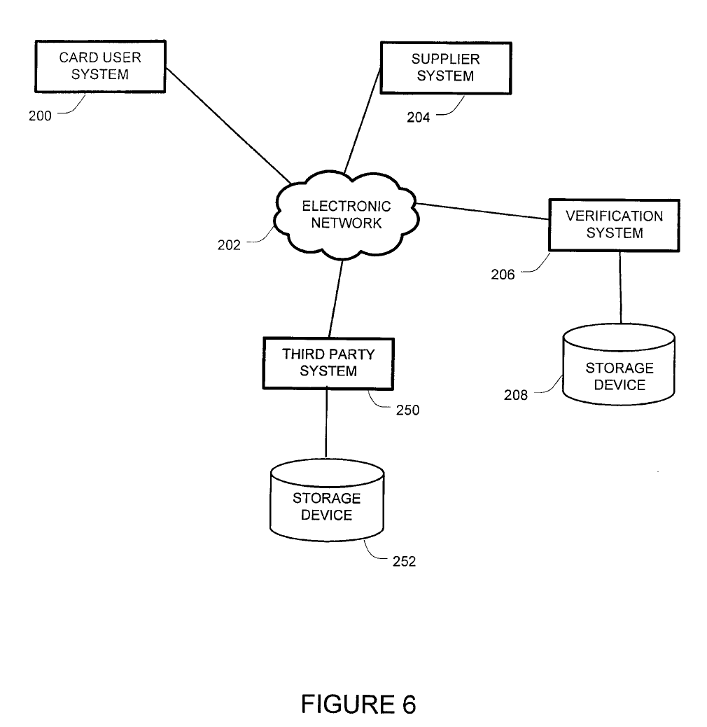

Such formatting of the card identifier and/or other data stored on the card may allow such data to be partitioned and extracted in a known way. When partitions representing the data are extracted, a table in a storage device such as shown in FIG. 5 or 6, may be used to look up the meaning of the data. By way of example, the identifier may include in a specifically-determined data field a data item representing the integer 5. A table in a storage device may indicate that the optical data card 20 was distributed at a tradeshow in San Francisco. As a further example, a user's bank account number and pin may be 87,334,1222;1234. This may be represented by random symbols and numbers such as Az8£β&2103;\1Xx. When the card identifier is partitioned (or otherwise formatted according to a predetermined number of data items or records, or according to a determined protocol), this data could be used to lookup, or associate to, the original information 87,334,1222;1234. This may obviate the need for encryption when sending data as will be further discussed below.

The format and specific data and contents of the card identifier are variable and such variations are within the scope of the present invention. The specific data may allow parties (merchant, supplier, producer of the optical data card 20 etc) to uniquely identify the card, determine its properties, and understand the method, timing and purpose for which it is being used. Other uses for the card identifier are also contemplated, and are considered to be within the scope of the present invention.

Drive opening 24 may allow the optical data-reading device, such as CD-ROM or DVD drive, to operationally register with optical data card 20. When optical data card 20 is initially introduced to an optical data-reading device, optical data card 20 may register with the optical data-reading device, via substrate 22 or seating device 32, substantially by being disposed in a tray that exerts forces that prevent translation of the optical card. In operation, many conventional optical data-reading devices rotate optical data cards 20 to read them. However, the tray does not typically exert forces to cause this rotation. Drive opening 24 therefore may allow an optical data-reading device to functionally register, with a spindle, to optical data card 20 to exert rotational forces, and rotate, optical data card 20. The radius of drive opening 24 may be constrained by the spindle of optical data-reading devices. Drive opening 24 may have a radius that is conventional, though other radii are within the scope of the present invention when required by optical data-reading devices.

Further, it is understood that optical data card 20 does not need to have a drive opening 24 to be read by an optical data-reading device. Drive opening 24 may be designed so as to functionally engage the optical data-reading device, or spindles, without having a drive opening 24 per se. Instead drive opening 24 may be solid material, for example using material that can be engaged by the spindles of an optical drive, or that has a three dimensional shape such as indentations, plateaus, shoulders, ridges, or troughs, that position and engage optical data card 20 with the optical data-reading device.

Placement area 26 is a ring-shaped area located radially exterior of drive opening 24 and radially internal to optical layer 30. Placement area 26 allows an optical data card 20 to be handled without risking damaging the datasets embedded in optical layer 30 in data area 28. The size and material of placement area is substantially flexible; its design is well known to those of skill in the art.

One or more seating devices 32 can be provided to allow the optical card 20 to engage with and be readable by an optical data reading device, such as a standard CD-ROM or DVD. For example, a credit-card sized optical card 20 according to the invention can include one or more devices configured for enabling the card 20 to be engaged by a loading tray of a CD and/or DVD drive, as described in any of the incorporated references.

For example, seating device 32 can comprise an edge 106 (FIG. 3) and/or shoulder, ridge or other protuberance or structure 108 as shown in FIG. 1, adapted for engaging an 8 cm ring in a currently-standard CD/DVD loading tray.

For example, seating device 32 may comprise a rounded edge 106, 108 or protrusion, of varying thickness, from the surface of optical layer 30 and may be made of plastic or another suitable material, for example polycarbonate or any other optical layer 30 material. Seating device 32 may be made of the same material as optical layer 30. Seating device 32 is configured to seat and abut an optical data card 20 in a loading tray of the optical data-reading device. To seat optical data card 20, seating device 32 may extend below optical layer 30 and be disposed in an optical data-reading device with at least a portion of its outer edge being radially in contact with a rounded section of an optical data-reading device, such as an inner ring of a CD/DVD tray. Alternatively, seating device 32 may form part of optical layer 30 wherein the layer extends below substrate 22 and is disposed in an optical data-reading device with at least a portion of its outer edge being radially in contact with a rounded section of an optical data-reading device such as an inner ring of a CD/DVD tray. As such, even if optical data card 20 is larger than the appropriate round section of the optical data-reading device optical data card 20 may be kept in place when it is being rotated and read.

Instead of or in addition to a rounded edge, seating device 32 may comprise a number of centering pins (not shown), as described in U.S. Pat. No. 6,016,298 and incorporated by reference above. Such centering pins may be located along the line of seating device 32, and may preferably comprise 2 to 4 centering pins on each side of seating device 32. Centering pins may further be located near four corners (or substantially evenly radially spaced around optical data card 20) of optical data card 20, and may be on the optical layer 30 side.

The centering pins are arranged in such a way that, when the optical data card 20 is inserted into the CD drive, the centering pins rest against a centering shoulder of the CD drive, and maintain the optical data card 20 centered.

Seating device(s) 32 can alternatively comprise centering beads arranged on both sides symmetrically relative to the drive opening 24 (not shown). Such centering beads can form a sector of a circle, wherein the radius is selected such that the outer edges of the centering beads rest against the loading tray closely enough to allow minimal play when the card 20 is placed in a compatibly-configured loading tray.

The technique for producing optical data card 20 and the arrangement of the seating device 32 (including rounded edge, centering pins, centering beads or other approaches) makes it possible to design optical data card 20 in approximately any desired shape, such as with approximately any desired outer contour, since optical data card 20 is centered in the drive by seating device 32 not by the exterior circumference defined by radius 108. For example, such an optical data card 20 can have the exterior contour of a company logo.

As noted, a variety of seating devices are described in co-owned U.S. Pat. Nos. 6,762,988, 5,982,736, and 6,016,298, the entire contents of which are incorporated by reference.

In some embodiments, the invention provides, in lieu of or in addition to seating device(s) 32, adapters configured for supporting the data card 20 in such manner that the card may be read by the optical- or non-optical reading device. For example, in lieu of or in addition to a shoulder 108 provided on card 20, a suitably-configured adapter may be provided to sit within a drive ring on a loading tray and engage one or more portions of the card 20 in such manner that it can be read by the optical or other reading device. As will be understood by those skilled in the relevant arts, depending upon the selected configuration of the card 20 and the intended reading device, a wide variety of suitably-configured adaptors may be provided.

Referring now to FIG. 1B, optical data card 20 further comprises magnetic stripe (or strip) 34. Magnetic stripe 34 is substantially similar to those disposed on traditional credit, debit or stored value cards. Magnetic stripe 34 may contain the same data and datasets, and operate in substantially the same manner as magnetic stripes of traditional credit, debit or stored value cards, and/or other data as described herein, including for example all or any subset of data stored in optically-readable format.

Magnetic stripes suitable for use in implementing embodiments of the invention may be substantially rectangular and have such measurements as are sufficient to store the desired amount of data, and preferably may have measurements in compliance with the standards of ANSI and/or ISO.

Magnetic stripe 34 may be made and coded using methods and materials as described in ISO or other standards and known to those of ordinary skill in the art. Magnetic stripe 34 may be disposed on substrate 22, on the opposite side of optical layer 30. Alternatively, magnetic stripe 34 may be disposed on optical layer 30, for example if optical layer 30 does not completely cover substrate 22. Alternatively, magnetic stripe 34 may be disposed on both the optical and non-optical layers of optical card 20.

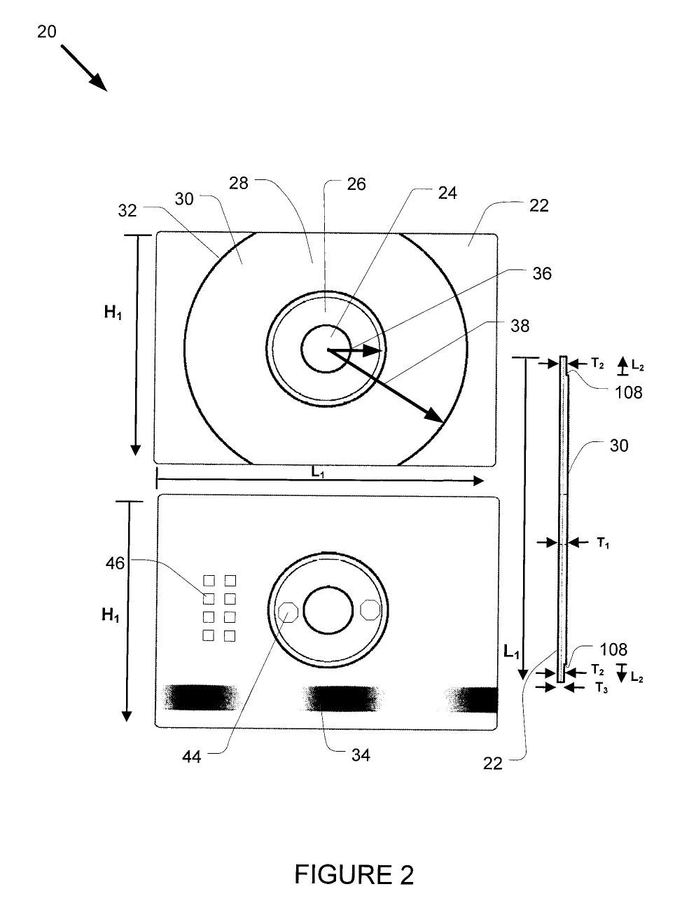

FIGS. 1A-1C and 2A-C show magnetic stripe 34 along the length of optical card device 20. While it may be desirable to dispose magnetic stripe 34 along the length, as is customary in traditional debit, credit and stored value cards, magnetic stripe 34 can be placed in any orientation on optical card 20 as long as such orientation that allows magnetic stripe 34 to have sufficient dimensions to accommodate the amount of data to be stored thereon.

Referring now to FIG. 1C, optical data card 20 is shown in side view. FIG. 1C shows three thicknesses, T1, T2 and T3, as well as two lengths L1 and L2. L1 corresponds L1 in FIG. 1A. L2 is a length extending from the outermost edge of either optical layer 30 or seating device 32, to the outermost edge of substrate 22. Such length is located at both the top and bottom of optical data card 22 in FIG. 1C. As can be seen in FIG. 1C, the thickness of optical data card 20 along lengths L2 (T2) may be different from the thickness along the rest of the length L1 (T1) of optical data card 20.

As shown in FIG. 1B, magnetic stripe 34 may be located on the left side of optical data card 20 along length L1 and extend substantially the entirety of L1, passing L2. Magnetic stripe 34 may thus be on a flat surface 30 that has different thicknesses over its length. In such an embodiment, it must be assured that all thicknesses (in the present case T1 and T2) both allow optical and non-optical data-reading devices to read data from optical data card 20.

In a further embodiment, magnetic stripe may be oriented to run along height H1 or FIG. 1A. In such an orientation, magnetic stripe may only be located along a portion of optical data card 20 having one thickness (T2 in FIG. 1C) Thickness T2 must therefore be such that a non-optical data-reading device can interact with the optical reading device in any manner necessary—however T1 is not so constrained. In addition to considering thickness T2, height H1 must therefore be sized to allow non-optical data-reading device (such as a magnetic swipe reader) to read optical data card 20.

In one embodiment of optical data card 20, T1 is about 0.95 mm, and includes about 0.12 mm thickness attributable to an adhesive, and T2 is about 0.72 mm.

FIGS. 2A, 2B and 2C together form an alternate optical data card in accordance with a further embodiment of the present invention, where FIG. 2A provides a top view, FIG. 2B provides a bottom view and FIG. 2C provides a side view.

Referring to FIG. 2A, a top view of an optical data card 20 is seen. The top view of optical data card 20 in FIG. 2A is substantially the same as the top view of optical data card 20 in FIG. 1A.

Referring to FIG. 2B, a bottom view of an optical data card 20 comprises the elements of FIG. 1B and further comprises one or more silicon chips 44 and contacts 46 for smart card readers.

Microcircuit devices 44 such as smart chips or other devices including miniature logic technologies may be implanted within optical data card 20 to enable smart card functionality and may be implanted within a pocket or recess in substrate 22. The pocket or recess in substrate 22 may be centered over, or around, drive opening 24 to maintain balance when optical data card 20 is being read, and hence possibly spun, by an optical data-reading device.

In alternative embodiments, the pocket may not be balanced, or centered relative to drive opening 24. In such an embodiment, counterbalancing materials may be added to optical data card 20 so that optical data card 20 may be read on high rotation speed by optical data-reading devices without causing excessive vibration. Although microcircuit devices 44 may be in substrate 22, in further embodiments, a pocket may be made in data area 28 of optical layer 30 without compromising either the data or strength of optical layer 30.

Contacts 46 for smart card readers may be similar to contacts specified by ISO 7816 or other suitable standard. Contacts 46 may be wired to the one or more devices 44, for example using thin-film circuits, or by embedding the connection wires between substrate 22 and optical layer 30.

In further embodiments (not shown), RFID and/or smart card components are embedded within substrate 22 or are included as one or more additional layers added between substrate 22 and optical layer 30. Thin film RFID and smart card technologies may be used to construct these additional layer(s). In these embodiments, RFID and/or smart card components may replace, or be in addition to, silicon chips 44 and contacts 46 and provide another format from which non-optical data-reading devices may read. In addition to RFID and/or smart card components, optical data card 20 may comprise bar codes or scratch fields.

Referring to FIG. 2C, a side view of an optical data card 20 is seen along a length. FIG. 2C is substantially the same as FIG. 1C. Although not shown in the side view of FIG. 2C, the thickness of optical data card 20 may vary slightly along L1 in response to slight perturbations caused by contacts 46 or silicon chips 44. Other means to provide non-optical data may likewise produce minor variances in thickness of optical data card 20.

FIG. 3 is a bottom view of an optical data card 20 in accordance with a further embodiment of the present invention. Optical data card 20 is substantially similar to optical data card 20 in FIGS. 1 and 2, however optical data card 20 has rounded edges 106.

In the embodiment shown in FIG. 3, rounded edges 106 are the outermost edge of optical data card 20. The shape of optical data card 20 may then substantially allow optical data card 20 to be inserted in a optical data-reading device, and register and be readable by that device, without requiring additional seating device 32.

It is also to be understood that the present embodiment, having rounded edges 106 may only have one rounded edge 106, or may have other shapes or features of the shape of the optical data card 20. The shape or features of the shape of the optical data card 20 of the present embodiment are intended to function to allow the optical data card 20 to register with the optical data-reading device.

FIG. 4 is a plan view of an optical data card in accordance with a further embodiment of the present invention. The embodiment shown in FIG. 4 is substantially similar to the embodiment shown in FIG. 3, further comprising magnetic stripe 34. While magnetic stripe 34 in FIG. 4 is shown on the optical layer 30 side of optical data card 20, it may be located on the opposite side of optical data card 20 and may be on substrate 22.

In the present embodiment, optical data card 20 can be read via a non-optical data-reading device, such as a conventional magnetic swipe reader despite the presence of rounded edges 106.

As shown in FIG. 4, magnetic stripe 34 is shown extending between two rounded edges (and substantially horizontally given the orientation of FIG. 4). However, in the embodiment shown in FIG. 4, the magnetic stripe 34 also could extend between the two straight edges (and substantially vertically given the orientation of FIG. 4), could be located closer to an edge of optical data card 20, or could be angled. Further, magnetic stripe 34 could be shorter than depicted, and may not extend the entire length, width or height, of optical data card 20. Magnetic stripe 34 simply must be of a suitable size to contain at least one dataset and be readable by a non-optical data-reading device.

Although not shown in FIG. 3 or 4, the embodiments in those figures may also have microcircuit devices 44 and contacts 46, substantially similarly to the embodiments shown in FIGS. 1 and 2. Such devices 44 and contacts 46, or other non-optical formats such as RFID, may replace the magnetic stripe in FIG. 4 or may provide another non-optical format for reading by a non-optical data-reading device.

FIG. 5 is a schematic diagram of a system suitable for implementing a transaction using an optical data card 20 in accordance with the present invention. In the embodiment shown, the system comprises at least one card user system 200, at least one supplier system 204 that can communicate with customer system 200 via communication network 202, and verification system 206 having storage device 208. As will be readily understood by those skilled in the relevant arts, the various multi-component systems shown in FIGS. 5 and 6 and described herein could also be implemented on a single stand-alone such as a PC desktop computer.

Card user system 200 may include a personal computer (PC), a PDA, mobile computer, cell phone or another computing device that may be used by a card user. Customer system 200 is able to read optical data card 20 through at least one of an optical data-reading device or a non-optical data-reading device. These may be integral to the customer system, such as an optical drive in a PC, or may be a peripheral that is connected to, and becomes part of, the customer system 200. Such a peripheral may be, for example, an external CD-ROM drive, magnetic swipe reader, or a smart card reader. Such peripherals may be connected to customer system 200 via a serial connection, a USB port, wireless communication or other contactless communication, infra-red communication or other ways as are known in the art.

Communication network 202 enables communication between customer system 200 and supplier system 204. Communication network may include, for example, a WAN such as the Internet or a LAN, and may be wired, wireless or any combination thereof. Communication network 202 may support encryption of data communicated between customer system 200 and supplier system 204, and may further provide that encryption. In the present embodiment of the system, shown in FIG. 5, communication network 202 preferably may be the Internet.

Communications between the various components of the systems shown in FIGS. 5 and 6, and/or otherwise useful in furthering transactions in accordance with the invention, can be made in encrypted or unencrypted formats. For example, signals provided by a card user system comprising a unique card identifier, a value to be associated with a purchase transaction, and/or other personal or financial information associated with a card user or other party, can be based on data read from an optical card 20, and encrypted to known or newly-developed encryption schemes, prior to being provided to or made accessible by any other parties or system components, and decrypted upon receipt, prior to any subsequent processing. The use of suitably encrypted data may be very beneficial in maintaining the security of transactions, and reducing or preventing loss through fraud, identity theft, misuse, etc. A wide variety of encryption/decryption schemes and devices suitable for use in implementing the processes described herein are now known, and doubtless others will hereafter be developed.

Supplier system 204 may include at least one personal computer, server, mobile computer, PDA, other computing device. Supplier system further may comprise a combination of one or more of any of the above that are connected or operate together via a communication network (not shown) which may be substantially similar to communication network 202 or may be different. In one exemplary embodiment, supplier system 204 comprises a plurality of personal computers and servers that are connected via a merchant's LAN.

Supplier system 204 may comprise inventory systems, distribution systems, point of sale systems and other systems (both hardware and software) that enable the performance of at least one of ecommerce transactions or in-store transactions.

Optional verification system 206 and associated storage device 208 may be operated by an issuer of an optical data card, such as a credit card company or a department store, or by a processing company employed by a card issuer, or other party. Further, verification system 206 may be operated by a different entity than storage device 208. Although supplier system 204, verification system 206 and storage device 208 are shown separately in FIG. 5, it is to be understood that they may be the same device, or may be located in the same system of devices, either geographically or in operation. Such further embodiments are considered within the scope of the present embodiment.

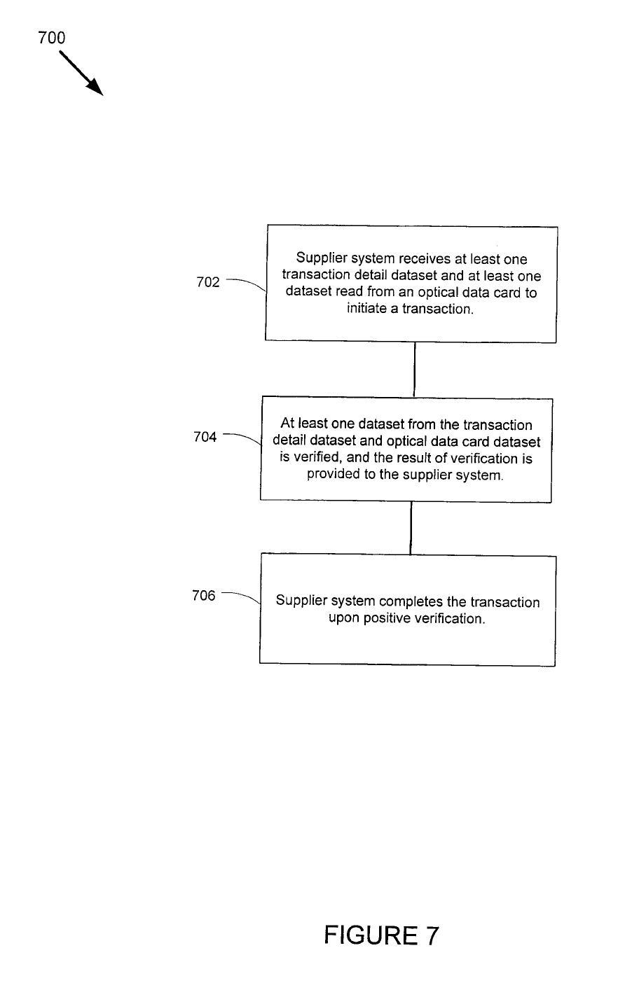

In an embodiment of a process for furthering a transaction using the system of FIG. 5, a card user introduces an optical data card 20 to card user system 200. Card user system 200 then reads at least one dataset (via at least one of an optical data-reading device or a non-optical data-reading device) from optical data card 20. The data set may be read automatically, as for example through use of automatically-executing code, execution of which is initiated by insertion of the card 20 into a reading device, or upon entry of an execution command by a user. For example, insertion of a card 20 into a card-reading device can cause a program stored on the card or on the computer to initiate a process whereby data, including a unique card identifier, is read from the optical card 20 and provided to the supplier system 204. One advantage provided by such an embodiment is that the security of a transaction or portion thereof may be increased because the unique card identifier (which may include financial and other sensitive data required for a transaction) may be difficult to intercept since it is not manually inserted into a transaction request and thus is not susceptible to a hacker's keystroke software. In addition, since it is not manually inserted into a transaction request, even if an unencrypted dataset is intercepted it would be extremely difficult to complete an unauthorized transaction because a hacker would not know how to submit the intercepted information in such as way that it would be accepted and authenticated by a verification system. The system described and shown in FIG. 5 may be further configured to incorporate other security features offered by the unique card identifier, as shown and described with reference to FIG. 7, including having an executable program embedded or having the card identifier be a random symbol or symbols that are later deciphered to derive meaning therefrom. As will be understood by those skilled in the relevant arts, a wide variety of processes suitable for causing such processes to be executed are now known, and will doubtless hereafter be developed.

In other embodiments it may be advantageous to require a user to enter such commands manually, using suitably-adapted command inputs.

Data read from card 20 and provided to the supplier system 204 may cause information to be displayed to the user that may for example lead to the user selecting a product to purchase from the merchant, via an ecommerce transaction. This may be accomplished, for example, by a dataset causing the merchant's webpage to load in a web browser, and the user then selects a product to purchase.

When the user selects a product to purchase, card user system 200 can communicate transaction data, via communication network 202, to supplier system 204. Transaction data provided by card user system 200 may include data from the at least one dataset from optical data card 20, such as a serialization number, and may include product details, data about the user, a value available for payment, and/or other data relating to the transaction.

The supplier system 204 can receive the transaction data via communication network 202 and initiate processing of the transaction. Exemplary steps in processing may include determining whether the product is available, whether it can be shipped to the user's location, debiting a value from an account identified by or otherwise associated with data provided by the card user system 200, and other steps suitable for processing transactions.

In addition to, or included in, processing the transaction, the supplier system 204 can communicate with one or more verification systems 206 to verify that a card identifier such as a serialization code provided by card user system 200 and sent to supplier system 204 via communication network 202 is known to the verifier, supplier, or other party, and useful in authorizing a transaction. Supplier system 204 may for example provide verification system 206 with the a card identifier, a purchase amount the user is attempting to spend using a value stored on or otherwise associated with an optical data card 20, and an identifier for supplier system 204 so the verification system can communicate back to supplier system 204.

Receiving this data from supplier system 204, verification system 206 performs operations to ensure that a value or account associated with optical data card 20 has enough value or credit to complete the transaction. This may be accomplished, for example, by referring to storage device 208, which may comprise a database of card identifiers and how much value or credit they have associated with them. After verifying whether optical data card 20 has enough value to complete the transaction, verification system 206 may communicate with supplier system 204 and indicate that the transaction may continue or that it may not.

If verification system 206 indicates that the transaction may continue, then the transaction can be completed. Supplier system 204 would then complete the transaction; this may involve getting the product out of inventory and initiating mailing the product. Supplier system 204 can then communicate with verification system 206 to indicate that the value associated with the card identifier should be reduced by the amount of the transaction. Verification system may then change that value in storage device 208, optionally by changing the value in a database, and optionally can cause value data stored on the optical card 20 in optically- and/or non-optically readable format to be updated accordingly.

In other alternative embodiments, card user system 200 and supplier system 204 may be in the same geographic area or may be the same device and may be operated by a card user or other user of any of customer system 200 or supplier system 204.

For example, a card user may enter a merchant's store with optical data card 20 and wish to make a purchase. The user may then introduce optical data card 20 to a card user system 200 and cause optically or non-optically formatted data on optical data card 20 to be read by the system 200. Card user system 200 may for example include a kiosk or point of sale terminal that is operable by a user or may simply be a POS terminal operated by an employee or cashier. Card user system may include one or more optical data-reading devices such as a CD-ROM drive, one or more non-optical data-reading device such as a magnetic swipe reader, or one or more optical and non-optical data-reading devices. In the present embodiment, the user may then scan the item they wish to purchase from the merchant if they did not do that prior to introducing optical data card 20 to the card user system 200. Card user system 200 can communicate with supplier system 204 via communication network 202, which could for example include a LAN that is located in the store.

Supplier system 204 can communicate with verification system 206 to ensure optical data card 20 has enough value to complete the transaction. Verification system may be geographically close to supplier system 204 and hence communication network 202 employed may be a LAN, or verification system 206 may be geographically far away from supplier system 204 and hence communication network 202 may be a WAN. If the card has enough value for the transaction to complete, the supplier system or the customer system may issue the user a receipt so they may depart the store.

Many alternative embodiments are considered within the scope of the present invention. Customer system 200 and supplier system 204 may be the same system. Supplier system 204 and verification system 206 may be the same system. Further, all three of customer system 200, supplier system 204 and verification system 206 may be the same system. In addition, although the card user may be the user that introduces optical data card 20 to customer system 200, an employee of the merchant may do the introducing and thus the transaction largely operates as a traditional in-store transaction.

FIG. 6 is a system for using an optical data card 20 in accordance with an alternate embodiment of the present invention. The embodiment in FIG. 6 comprises at least one third party system 250 and an associated storage device 252.

Third party system 250 may be, for example, a banking institution system, a credit card institution system or the like. The embodiment shown in FIG. 6 allows a user to perform other operations with optical data card 20 including: topping up the card by transferring funds from bank accounts, credit cards, telephone cards, and the like or other financial transactions falling outside of the usual scope of ecommerce transactions and that therefore might not be supported by supplier system 204 alone.

FIG. 7 is a flowchart for using an optical data card in accordance with an embodiment of the present the invention.

Process 700 of FIG. 7 provides one embodiment of a process for using optical data card 20 to complete a transaction. At 702 a supplier system (such as supplier system 204 of FIG. 5 or 6) receives at least one transaction detail dataset and at least one dataset read from an optical data card (such as optical data card 20) to initiate a transaction. At least one dataset may be encrypted prior to being received by the supplier system.

The at least one transaction detail dataset may be received by the supplier system from a customer system (such as customer system 200 of FIG. 5 or 6) or a user input provided to the supplier system. The customer system may be any system that can be used to carry out e-commerce transactions. In one embodiment at 702, the supplier system receives the at least one transaction detail dataset from a web-based communication initiated by a user. This may be, for example, from a web page loaded on a customer system that the user interacts with to initiate the transaction. In an alternative embodiment, a user may be in a store and may enter the transaction detail dataset directly to the supplier system.

The at least one dataset may include, for example, a unique card identifier, as described above. The at least one transaction detail dataset may include transaction details such as a product being purchased (identified by, for example, its SKU number), the cost of the product being purchased, a store identifier or location, a user or customer identifier, and any other details relating to the transaction. The at least one transaction detail dataset may be substantially similar to transaction details that are required to complete any e-commerce transaction.

In a further embodiment, the at least one dataset read from an optical data card may be automatically read by an optical data-reading device, so that a card user does not need to know, remember, or manually insert the at least one dataset. A user may not need to manually insert any financial information, such as credit, debit, or stored value card numbers, or any other financial information into a transaction request because such information is automatically provided by, or is associated with, such at least one dataset.

In accordance with an embodiment of the invention, a supplier may use any means known in the art to initiate a transaction wherein a user is not required to manually provide information, such as financial or identification information.

In a yet alternative embodiment, the at least one dataset may be either pushed to the supplier system or pulled to the supplier system and may be encrypted, by a supplier's software or by a user system, prior to being pulled by, or pushed to, a merchant's software.

The at least one data set read from an optical data card may be read by a non-optical data-reading device or by an optical data-reading device. The optical data-reading device and the non-optical data-reading device may be substantially similar to those devices discussed above, and may include a CD-ROM, DVD-ROM, magnetic swipe reader, RFID reader, smart card reader, or other optical and non-optical data-reading devices capable of reading data from an optical card in accordance with this invention.

In one embodiment of process 700 at 702, the transaction detail dataset and the dataset read from an optical data card are received by the supplier system together and may be received from, for example, a customer system. This may occur, for example, by a webpage assembling both datasets prior to communicating to supplier system. The at least one detail dataset, if encrypted, may be decrypted at 702 or may remain encrypted.

After a supplier system receives the at least one dataset at 702, process 700 continues to 704 where at least one dataset from a transaction detail dataset and optical data card dataset is verified and the result of verification is provided to the supplier system.

At 704 there may be datasets from 702 that do not require verification; they may be provided to allow the transaction to proceed. For example transaction details may include the product that the user may wish to purchase. At 704 that transaction detail may be used, for example, to determine whether that product is in inventory and therefore the transaction can proceed, from an availability of inventory perspective. Other such processing is envisioned at 704, and includes processing generally required to complete e-commerce transactions.

The at least one data set that is verified at 704 may include, for example, a serialization identifier and a transaction amount. In one embodiment of process 700 the serialization identifier and the transaction amount are verified to ensure that the optical data card associated with the serialization identifier has enough credit or value to complete the transaction (ie. to pay the transaction amount). Therefore, providing the results of verification may comprise providing an indicator to the supplier system of whether the optical data card can pay for the intended product. Verification may also ensure that the user attempting to complete the transaction is the authorized user.

The result of verification may be provided by the supplier system itself or may be provided by a system external to the supplier system, for example a verification system. If the verification occurs external to the supplier system and the at least one dataset was encrypted, it may remain encrypted when being communicated between the supplier system and the external verification system. If the verification occurs at the supplier system, decryption may occur at 702 or 704—at the supplier system.

In either event the process 700, at 704, requires verification and this verification is received by the supplier system.

Process 700 then continues at 706 where the supplier system completes the transaction if it receives positive verification. At 706 the supplier system performs or initiates typical e-commerce processing such as obtaining the product from inventory and shipping the product to a user. Further, at 706, the supplier system may update the amount of value or credit associated with the optical data card having the serialization identifier that was read. This may involve providing at least one update dataset to the verification system or simply updating the supplier system itself if the information to be updated is stored there.

As previously noted, one advantage provided by the use of a data card 200 in accordance with process 700 and other processes, systems, and devices in accordance with the invention is that the security of a transaction or portion thereof may be increased. For example, the use of cards 20 and transmission of data in accordance with the invention permits a more secure online transaction because the at least one dataset may be difficult to intercept since it is not manually inserted into a transaction request and thus is not susceptible to a hacker's keystroke software. In addition, since it is not manually inserted into a transaction request, even if an unencrypted dataset is intercepted it would be extremely difficult to complete an unauthorized transaction because a hacker would not know how to submit the intercepted information in such as way that it would be accepted and authenticated by a verification system.

According to embodiments of the invention where the at least one dataset comprises random symbol or symbols (such as a unique card identifier that has an unknown format and whose meaning requires looking up in a storage device), such symbol or symbols may be first deciphered or given meaning with reference to a storage device or lookup table at the verification system, and then verified. In such an embodiment, a user's financial data (such as, for example, a credit, debit or stored value account number and/or expiration date) may then be transmitted, preferably encrypted, by a verification system to a merchant system if the transaction request is authorized. It is to be understood that deciphering and verification may occur at the supplier system, thus obviating the need for encryption at all.

According to another embodiment of the invention an optical data card 20 comprises stored data, which may include a unique serialization number or other card identifier and also has recorded thereon a program and/or one or more suitably-adapted execution commands, preferably encrypted, having a user's financial information. Such financial information can be transmitted to a supplier system and may be executed to provide such financial information. The dataset, or unique card identifier, is then transmitted to the verification system. If an authorization is received then the stored financial data is processed to complete the transaction request.

It will be apparent to one of skill in the art that a great many different ways of transmitting data containing at least one dataset, such as a unique card identifier, are possible in addition to the examples given above, all of which result in a secure online transaction according to embodiments of the present invention.

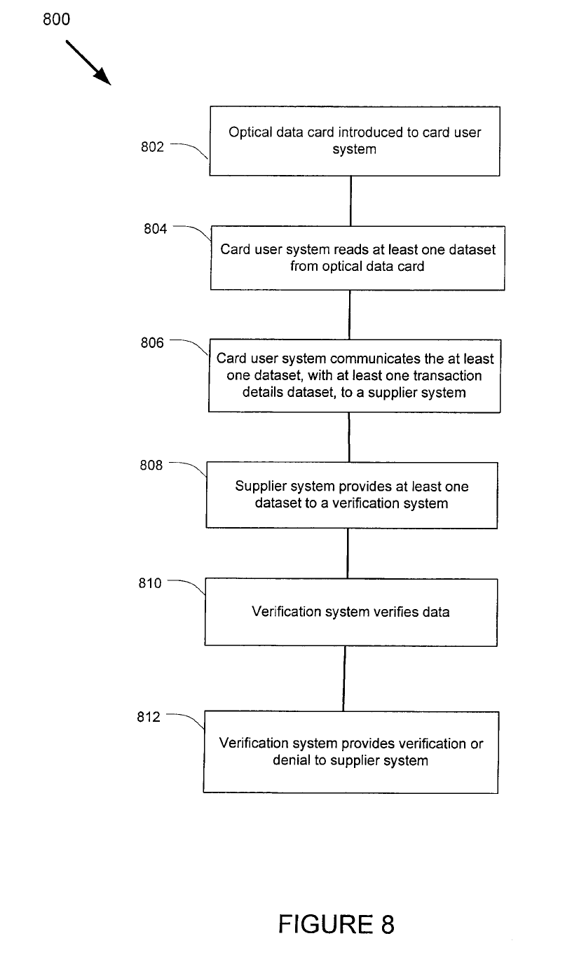

FIG. 8 is a flowchart for using an optical data card in accordance with an alternate embodiment of the present the invention.

Process 800 provides an alternative embodiment of a process for using an optical data card to carry out a transaction. Process 800 may be, for example, an e-commerce transaction that is carried out over the internet. Process 800 may also be applied to an in-store transaction.

Process 800 begins at 802 where an optical data card is introduced to a customer system. Introducing an optical data card may involve such optical data card being placed in an optical reading device such as for example, a CD-ROM or DVD-ROM drive, or being read by a non-optical data-reading device such as for example being swiped through a magnetic swipe reader or being read by an RFID reader or a smart card reader.

At 804 the customer system reads at least one data set from an optical data card—via a non-optical data reading device such as a magnetic swipe reader or via an optical data reading device such as a CD-ROM or DVD. The at least one data set read at 804 may include details about the optical data card, the user or owner of the optical data card and may include a serialization identifier, that identifies the optical data card.

Process 800 continues at 806 where the customer system communicates the at least one dataset read from the optical data with at least one transaction detail dataset to a supplier system. The at least one transaction detail dataset is substantially similar to the transaction detail dataset at 702 in process 700, and may be obtained in substantially the same way.

Process 800 then continues at 808 where the supplier system provides at least one data set to a verification system and may include providing at least one data set from the transaction detail dataset and at least one dataset from the optical data card. In one embodiment of process 800 the at least one data set at 808 comprises a serialization identifier of the optical data card and a transaction amount.

The verification system that receives the at least one data set at 808 may be located geographically close to, or far away from, the supplier system or may be the same system as the supplier system. Depending upon the geographic location, and whether the verification system and supplier system are the same system, communication between the verification system and supplier system may be accomplished by a LAN, WAN, or by structures internal to a supplier system having a verification system.

At 810 the verification system verifies the at least one data set from 808. In one embodiment of process 800 the verification system verifies that the optical data card, having the serialization identifier provided, has enough credit or value to complete the transaction and purchase the product.

The result of the verification at 810 can provided to the supplier system at 812. If the verification is positive, or the transaction is authorized, then at 812 the supplier system may continue to complete the transaction. Completing the transaction at 812 is substantially similar to the completion of the transaction at 706.

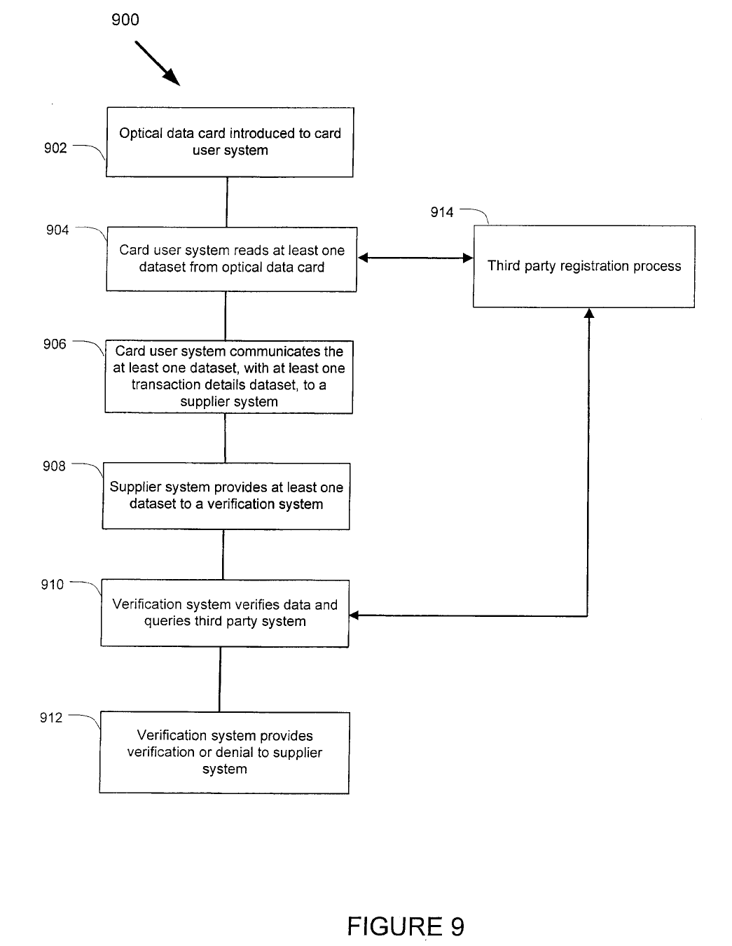

Referring to FIG. 9, another embodiment of the invention includes a third party system 300 and storage device 302 wherein each at least one dataset, which may be a unique card identifier is matched with a corresponding user's financial information. According to this embodiment, a third party, such as an optical data card manufacturer, embeds at least one dataset, which may be a unique card identifier in data area (such as data area 28) of an optical data card 20 and stores it in storage device 302. When a card user receives an optical data card 20 and first inserts it into an optical data-reading device of a customer system (such as 200), the optical data-reading device reads the embedded dataset.

At 101, such embedded dataset is then either pushed to or pulled by third party system 300, for a one-time registration process. A third party system 300 then sends a request to customer system 200, asking a user to register the optical data card 20. A user's response is associated with such dataset (which may again, be a unique card identifier) and stored in storage device 302. Such registration process is a one-time process performed when a user first uses an optical data card 20.

During a verification process, a verification system performs an additional step 111 of querying a third party system to check the identity of a user corresponding to the dataset. A third party system checks an associated storage device and transmits a response to a verifying system. A verifying system then checks associated storage device and at 112 transmits an authorization or a denial to a merchant computer 12.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed:

1. An optical data card configured for reading by a non-optical data-reading device, the data card comprising:
a substrate supporting at least one data set, the at least one data set readable by an optical data-reading device and the same or an other data set readable by the non-optical data-reading device; and
a seating device configured to seat the optical data card in the optical reading device.

2. The optical data card of claim 1, wherein:
the at least one data set readable by an optical data-reading device comprises data encoded in a first format and representing a unique card identifier; and
the at least one data set readable by the non-optical data-reading device comprises data encoded in a second format and representing the same unique card identifier.

3. The optical data card of claim 1, wherein the at least one data set readable by the non-optical data-reading device is stored by at least one of a magnetically-encoded data strip, a radio-frequency identification device, and a microcircuit device.

4. The optical data card of claim 1, wherein the at least one data set readable by the non-optical data-reading device is stored by a magnetically-encoded data strip and a portion of the card comprising the magnetically-encoded data strip comprises a thickness of less than about one and two-tenths (1.2) millimeters.

5. The optical data card of claim 1, wherein the seating device comprises an edge of the optical card configured so that at least portions of the edge abut with a loading tray of the optical reading device.

6. The optical data card of claim 1, wherein the seating device comprises at least one protrusion configured to abut a loading tray of the optical reading device.

7. The optical data card of claim 1, wherein the at least one data set is rewriteable.

8. The optical data card of claim 1, wherein the at least one data set read-only.

9. The optical data card of claim 1, comprising a plurality of data sets, at least one data set being rewritable and at least one other data set being read-only.

10. An optical data card configured for reading by a non-optical data-reading device, the data card comprising:
at least one data set readable by an optical data-reading device, the data set readable by an optical data-reading device comprising data encoded in a first format and representing a unique card identifier; and
at least one data set readable by the non-optical data-reading device, the data readable by a non-optical data-reading device comprising data encoded in a second format and representing the same unique card identifier.

11. The optical data card of claim 10, wherein at least one of the data encoded in the first format and the data encoded in the second format is rewriteable.

12. The optical data card of claim 10, wherein at least on of the data encoded in the first format and the data encoded in the second format is read-only.

13. The optical data card of claim 10, wherein the at least one data set readable by the non-optical data-reading device is stored by at least one of a magnetically-encoded data strip, a radio-frequency identification device, and a microcircuit device.

14. The optical data card of claim 13, wherein the at least one data set readable by the non-optical data-reading device is stored by a magnetically-encoded data strip and a portion of the card comprising the magnetically-encoded data strip comprises a thickness of less than about one and two-tenths (1.2) millimeters.

15. A system useful for processing a transaction between a card user and a supplier, the system comprising at least one data processor configured to:
receive from a card user system a signal configured for causing the processor to initiate a transaction process, the signal generated by the card user system upon reading of an optical data card by an optical reading device associated with the card user system;
receive from the card user system, as a part of the same or another signal, data read from the optical data card and representing a card identifier associated with the optical card; and
using the received signal or signals, output signals representing data useable by a supplier system for furthering a transaction.

16. The system of claim 15, wherein the data representing a card identifier and received by the processor from the customer system is read from the optical data card in at least two formats, a first format compatible with reading by an optical data-reading device and a second format compatible with reading by a non-optical data-reading device.

17. A system useful for processing a transaction between a card user and a supplier, the system comprising at least one data processor configured to:
receive from a card user system comprising an optical data-reading device and a non-optical data-reading device signals representing data read from an optical data card, the read data stored on the optical data card in optically-readable form and in non-optically-readable form;
using the received data, output signals representing data useable by a supplier system for furthering a transaction.

18. The system of claim 17, wherein data read from the optical data card and received by the processor from the customer system comprises data encoded in at least two formats and representing a unique card identifier, a first format compatible with reading by an optical data-reading device and a second format compatible with reading by a non-optical data-reading device.

19. The system of claim 17, wherein the data set stored in non-optically readable form is stored by at least one of a magnetically-encoded data strip, a radio-frequency identification device, and a microcircuit device.

20. The system of claim 17, wherein the output signals useable by a supplier system are stored in memory by the processor.

21. The system of claim 17, wherein the output signals useable by a supplier system are further processed by the processor in furtherance of the transaction.

22. A method of processing data useful for processing a transaction between a card user and a supplier, the method performed by at least one data processor and comprising:
receiving from a card user system a signal configured for causing the processor to initiate transaction process, the signal generated by the card user system upon reading of an optical data card by an optical data-reading device associated with the card user system;
receiving from the card user system, as a part of the same or another signal, data read from the optical data card and representing a unique card identifier associated with the optical card; and
using the received signal or signals, outputting signals representing data useable by a supplier system for furthering a transaction.

23. The method of claim 22, wherein the data representing a card identifier and received by the processor from the card user system is encoded on the optical data card in at least two formats, a first format compatible with reading by an optical data-reading device and a second format compatible with reading by a non-optical data-reading device.

24. A computer usable medium having computer readable code embodied therein for causing a processor to:
receive from a card user system a signal configured for causing the processor to initiate a transaction process, the signal generated by the card user system upon reading of an optical data card by an optical reading device associated with the card user system;
receive from the card user system, as a part of the same or another signal, data read from the optical data card and representing a unique card identifier associated with the optical card; and
using the received signal or signals, output signals representing data useable by a supplier system for furthering a transaction.

25. The medium of claim 24, wherein the data representing a unique card identifier and received by the processor from the card user system is encoded on the optical data card in at least two formats, a first format compatible with reading by an optical data-reading device and a second format compatible with reading by a non-optical data-reading device.

26. An optical data card useful in completing an electronic transaction, the optical data card comprising:
an optically-readable data set supported by a substrate, the optically-readable data set comprising data representing a unique card identifier; and
a seating device configured to seat the optical data card an optical reading device.
